(19) United States
(12) Patent Application Publication
(10) Pub. No.: US 2025/0317943 A1
(43) Pub. Date: Oct. 9, 2025

(54) SIDELINK REQUEST/GRANT PROTOCOL FOR WIRELESS NETWORKS

(71) Applicant: Lenovo (Singapore) Pte Limited, Singapore (SG)

(72) Inventors: Karthikeyan GANESAN, Nauheim (DE); Ravi KUCHIBHOTLA, Chicago, IL (US)

(21) Appl. No.: 18/860,461

(22) PCT Filed: Apr. 26, 2023
(86) PCT No.: PCT/IB2023/054316

§ 371 Date: Oct. 25, 2024

Related U.S. Application Data
(60) Provisional application No. 63/335,090, filed on Apr. 26, 2022.

(51) Int. Cl. H04W 72/25; H04W 72/30; H04W 74/0808

(52) U.S. Cl. CPC H04W 72/25; H04W 72/30; H04W 74/0808

(57) ABSTRACT

A transmitting (Tx) User Equipment (UE) and one or more Receiving (Rx) UE may perform a sidelink communication in an unlicensed band using a clearance request/grant handshake. The clearance request/grant handshake may comprise transmitting, by the Tx UE using radio resource allocated to the sidelink communication, a clearance request broadcast signal indicating the one or more Rx UEs. The clearance request/grant handshake completes successfully when the Tx UE receives, from one or more of the Rx UEs, a clearance grant signal corresponding to the first clearance request broadcast signal. The sidelink communication is performed in response to the successful completion of the clearance request/grant handshake.

### CROSS REFERENCE TO RELATED APPLICATIONS

This application claims priority to U.S. Provisional Patent Application No. 63/335,090, filed on Apr. 26, 2022, entitled SIDELINK REQUEST/GRANT PROTOCOL FOR WIRELESS NETWORKS, which is hereby incorporated by reference in its entirety.

### TECHNICAL FIELD

The present disclosure relates to wireless communications, and more specifically to sidelink communications conducted in an unlicensed band by elements of a wireless communication system.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, including time resources (e.g., symbols, slots, subframes, frames, or the like), frequency resources (e.g., subcarriers, carriers), or combinations thereof. Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

UEs in a wireless communications system may be configured to conduct sidelink communications with other UEs, or more generally, with other devices other than a base station. Sidelink communications are distinguished from other communications (such as uplink (UL) and downlink (DL) communications) in that the sidelink communications are not communicated through a base station, but instead involve direct radio-frequency (RF) communication between the two UEs that are transferring or exchanging information.

When a sidelink communication is performed in an unlicensed band, the RF resources used by a sidelink communication between two UEs may be shared with other devices, which may create issues that the sidelink communication protocols may be adapted to ameliorate.

### SUMMARY

The present disclosure relates to methods, apparatuses, and systems that support sidelink communications using an unlicensed band by devices in a wireless communications system. The devices may be UEs communicating directly with other UEs. Because resource allocation for the sidelink communications may be performed by a distributed mechanism, situations such as the exposed node problem and the hidden node problem may arise, which may increase the probability that performance-degrading frame collisions may occur. The present disclosure relates to reducing the probability that such frame collisions may occur, thus improving the performance of the wireless communications system.

Some implementations of the method and apparatuses described herein determine whether to perform a clearance request/grant handshake before performing a sidelink communication with one or more receiving (Rx) UEs in an unlicensed band, and in response to determining to perform the clearance request/grant handshake, perform a first clearance request/grant handshake and perform the sidelink communication with the one or more Rx UEs in response to successful completion of the first clearance request/grant handshake. The first clearance request/grant handshake comprises transmitting, by the Tx UE using radio resources allocated to the sidelink communication, a first clearance request broadcast signal indicating the one or more Rx UEs. The clearance request/grant handshake completes successfully when the Tx UE receives, from one or more of the Rx UEs, a clearance grant signal corresponding to the first clearance request broadcast signal.

In some implementations of the method and apparatuses described herein, indicating the one or more Rx UEs in the first clearance request broadcast signal is performed using one or more source-destination identifiers.

In some implementations of the method and apparatuses described herein, the method and apparatuses determine to perform the clearance request/grant handshake based on a level of wireless network congestion, a priority of traffic to be communicated in the sidelink communication, or a combination thereof.

In some implementations of the method and apparatuses described herein, the first clearance request/grant handshake completes unsuccessfully when the Tx UE does not receive a clearance grant signal corresponding to the first clearance request broadcast signal from one or more of the Rx UEs before the expiration of a timeout interval.

In some implementations of the method and apparatuses described herein, the first clearance request/grant handshake completes unsuccessfully when the Tx UE receives a signal indicating that the sidelink communication should not be performed from a UE other than the one or more Rx UEs.

In some implementations of the method and apparatuses described herein, the method and apparatuses, in response to determining to not perform the clearance request/grant handshake, perform the sidelink communication without performing the clearance request/grant handshake.

In some implementations of the method and apparatuses described herein, the sidelink communication is a Channel Occupancy Time (COT) sharing communication.

In some implementations of the method and apparatuses described herein, the method and apparatuses, in response to the first clearance request/grant handshake completing unsuccessfully, perform a second clearance request/grant handshake by transmitting a second clearance request broadcast signal indicating one or more Rx UEs other than the one or more Rx UEs indicated in the first clearance request broadcast signal.

In some implementations of the method and apparatuses described herein, the clearance grant signal comprises a source-destination identifier corresponding to a source-destination identifier included in the first clearance request broadcast signal, information on a signal strength of the first clearance request broadcast signal at a UE transmitting the clearance grant signal, information on an amount of interference present at the UE transmitting the clearance grant signal on radio resources pertinent to the sidelink communication, or a combination thereof.

In some implementations of the method and apparatuses described herein, the first clearance request broadcast signal is transmitted on a plurality of transmission beams, the clearance grant signal is received using the plurality of transmission beams, and one or more measurements of the respective channel characteristics of the plurality of transmission beams are used to select a transmission beam for subsequent data transmission of the sidelink communication.

Some implementations of the method and apparatuses described herein receive, from a transmitting (Tx) UE, a clearance request broadcast signal regarding a sidelink communication in an unlicensed band, determine whether the clearance request broadcast signal identifies the method and apparatuses as participating in the sidelink communication, and in response to determining that the clearance request broadcast signal identifies the identifies the method and apparatuses as participating in the sidelink communication, determine whether to grant the Tx UE clearance to perform the sidelink communication.

In some implementations of the method and apparatuses described herein, the method and apparatuses, in response to determining to grant the Tx UE clearance to perform the sidelink communication, transmit a clearance grant signal to the Tx UE.

In some implementations of the method and apparatuses described herein, the clearance grant signal includes an identifier corresponding to an identifier included in the clearance request broadcast signal, information regarding a received signal strength of the clearance request broadcast signal, information regarding interference present at the method and apparatuses, or a combination thereof.

In some implementations of the method and apparatuses described herein, transmitting the clearance grant signal to the Tx UE includes performing a Listen Before Talk operation before transmitting the clearance grant signal to the Tx UE.

In some implementations of the method and apparatuses described herein, determining whether the clearance request broadcast signal identifies the method and apparatuses as participating in the sidelink communication includes comparing an identifier included in the clearance request broadcast signal to an identifier associated with the method and apparatuses.

In some implementations of the method and apparatuses described herein, the method and apparatuses, in response to determining not to grant the Tx UE clearance to perform the sidelink communication, transmit a signal to the Tx UE indicating that the sidelink communication is not to be performed.

In some implementations of the method and apparatuses described herein, the sidelink communication is a Channel Occupancy Time (COT) sharing communication.

In some implementations of the method and apparatuses described herein, the method and apparatuses, in response to determining that the clearance request broadcast signal does not identify the method and apparatuses as participating in the sidelink communication, terminate a communication being performed by the method and apparatuses, perform a back-off operation, or both.

In some implementations of the method and apparatuses described herein, the method and apparatuses, in response to determining that the clearance request broadcast signal does not identify the method and apparatuses as participating in the sidelink communication, when a priority indicated in the clearance request broadcast signal is lower than a priority of pending traffic of the method and apparatuses, transmit a signal to the Tx UE indicating that the Tx UE should not perform the sidelink communication.

### BRIEF DESCRIPTION OF THE DRAWINGS

FIG. 1 illustrates an example of a wireless communications system that supports sidelink communications in accordance with aspects of the present disclosure.

FIG. 2 illustrates slot structures for NR sidelink communications in accordance with embodiments of the present disclosure.

FIGS. 3A through 3C illustrate performing sidelink communications in accordance with embodiments of the present disclosure.

FIG. 4 illustrates performing sidelink communications in accordance with another embodiment of the present disclosure.

FIG. 5 is a block diagram of a device that supports sidelink communications in accordance with aspects of the present disclosure.

FIGS. 6 and 7 illustrate flowcharts of methods that support sidelink communications in accordance with aspects of the present disclosure.

### DETAILED DESCRIPTION

Embodiments relate to channel access mechanisms for sidelink communications in unlicensed bands in wireless communications systems. In particular, embodiments of the present disclosure address the hidden node and exposed node situations that may occur when performing such sidelink communications in a New Radio in Unlicensed Spectrum (NR-U) environment.

Embodiments of the present disclosure provide an handshake protocol that may prevent the initiation of a sidelink communication in unlicensed band when interference at one of the devices participating in the sidelink communication makes performing the sidelink communication infeasible. The handshake protocol includes a prospective initiator of a sidelink communications (referred to herein as the Transmitting UE (Tx UE)) transmitting a request to perform the sidelink communication, and a recipient of the request (referred to herein as the Receiving UR (Rx UE)) transmitting a clearance to perform the sidelink communication when conditions at the Rx-UE do not make the sidelink communication infeasible.

Considering the distributed resource allocation mechanism used in sidelink communications, such a protocol should lessen the performance degradation caused by frame collisions and similar phenomena.

Aspects of the present disclosure are described in the context of a wireless communications system. Aspects of the present disclosure are further illustrated and described with reference to device diagrams, flowcharts, data flow diagrams, and data model diagrams that relate to a clearance request/grant handshake for use in performing sidelink communications in an unlicensed band.

Table 1, below, provides a list of abbreviations that may be used herein:

TABLE 1
Abbreviations

| | | | |
|---|---|---|---|
| 3GPP | 3rd Generation Partnership | gNB | Next Generation Node B |
| | Project | | |
| ACK | Acknowledgment | OFDM | Orthogonal Frequency Division |
| | | | Multiplexing |
| CAPC | Channel Access Priority Class | OFDMA | Orthogonal Frequency Division |
| | | | Multiple Access |
| CBG | Code Block Group | PSSCH | Physical Sidelink Shared Channel |
| CCA | Clear Channel Assessment | PSFCH | Physical Sidelink Feedback |
| | | | Channel |
| CG | Configured Grant | PSCCH | Physical Sidelink control channel |
| CN | Core Network | RRC | Radio Resource Control |
| COT | Channel Occupancy Time | TB | Transport block |
| CWS | Contention Window Size | TCI | Transmission Configuration |
| | | | Indicator |
| DG | Dynamic Grant | TDD | Time Division Duplex |
| DL | Downlink | TDM | Time Division Multiplexing |
| FDM | Frequency Division | TDRA | Time Domain Resource Allocation |
| | Multiplexing | | |
| FDMA | Frequency Division Multiple | UE | User Entity/Equip. (Mobile |
| | Access | | Terminal) |
| HARQ | Hybrid Automatic Repeat | SL | Sidelink |
| | Request | | |
| IoT | Internet-of-Things | ED | Energy Detection |
| IIoT | Industrial Internet-of-Things | MCR | Minimum Communication Range |
| LBT | Listen Before Talk | SEC | Short exemption control signaling |
| LTE | Long Term Evolution | CO | Channel occupancy |
| MIMO | Multiple Input Multiple Output | RTS | Request to transmit |
| NR | New Radio | CTS | Clear to send |
| NR-U | NR in Unlicensed spectrum | SCI | sidelink control information |

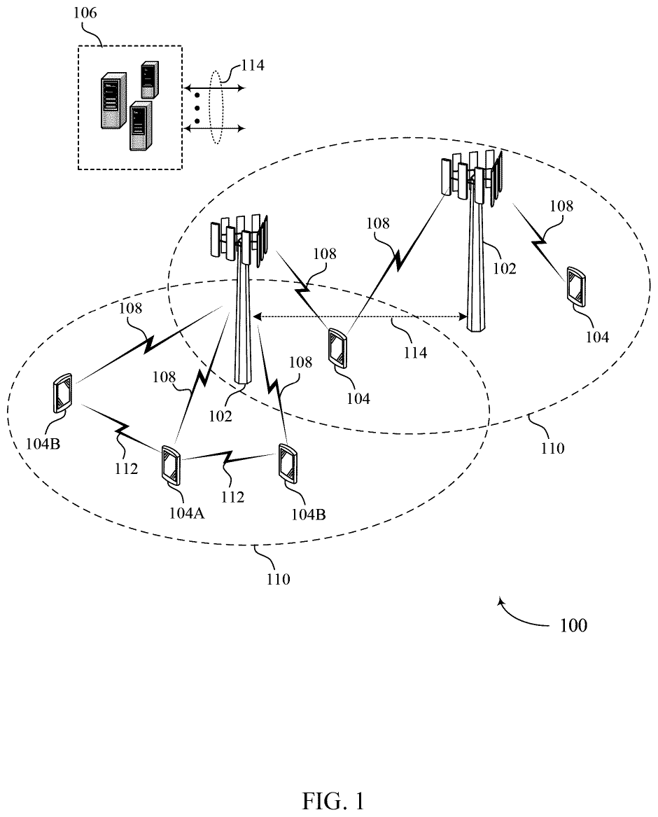

FIG. 1 illustrates an example of a wireless communications system 100 that supports sidelink communications in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a 3^{rd} Generation Partnership Project (3GPP™) New Radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a network entity, a network communication device, a base transceiver station, an access point, a NodeB, an eNodeB (eNB), a next-generation NodeB (gNB), or other suitable terminology. A base station 102 and a UE 104 may communicate via a communication link 108, which may be a wireless or wired connection.

The base stations 102 may respectively provide geographic coverage areas 110 for which each base station may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, one or more of the base stations 102 may be moveable, for example, a satellite associated with a non-terrestrial network. In some implementations, the geographic coverage areas 110A and 110B may be associated with the same or different radio access technologies and may overlap, but the different geographic coverage areas 110 may be respectively associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly. In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may comprise one or more computers and associated communication interconnects, and may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), one or more access and mobility management functions (AMFs), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112; the communication link 112 may be a sidelink 112. For example, a first UE 104A may support wireless communication directly with one or more second UEs 104B over a device-to-device (D2D) communication link. For example, a UE 104 may support wireless communication directly with another UE 104 over a PC5 interface. The UEs 104 may support single-cast, multi-cast, and broadcast sidelinks 112

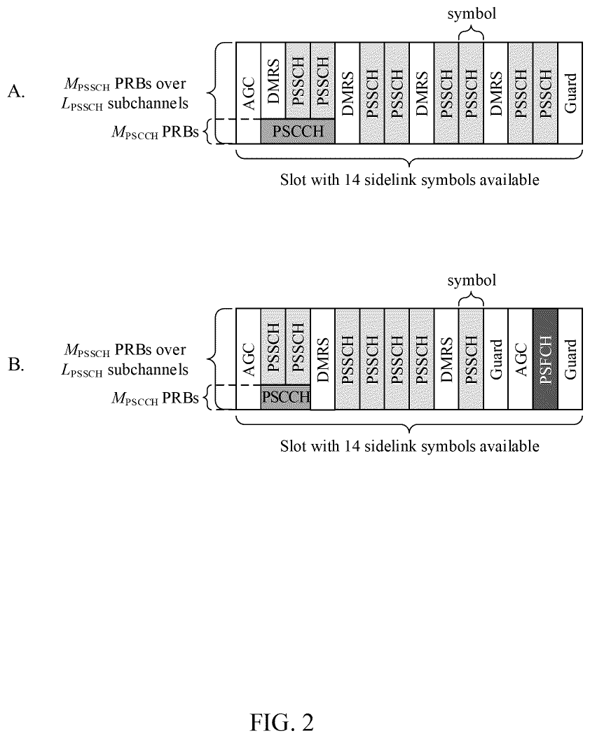

FIG. 2 illustrates slot structures for NR sidelink communications in accordance with embodiments of the present disclosure. In embodiments, NR sidelink communications are conducted using radio frames, which may have a duration of 10 milliseconds. Each radio frame may be divided into 10 subframes, which may have a duration of 1 millisecond. Each subframe may have a variable number of slots, according to the symbol rate and the number of symbols per slot.

In FIG. 2, A shows a structure for a slot that does not have a PSFCH, and B shows a structure for a slot that has a PSFCH. Each of the slots shown includes 14 symbols, but embodiments are not limited thereto, and a slot may be pre-configured to have 7 to 14 symbols. M_{PSSCH} is a number of physical resource blocks (PRBs) in the slot, L_{PSSCH} is a number of sub-channels used to perform the sidelink communication, and M_{PSCCH} is a number of PRBs used to communicate the PSCCH.

In an NR sidelink communication, the PSSCH can be transmitted starting from the second sidelink symbol and ending with the second to last sidelink symbol in a slot. Accordingly. PSSCH can be sent in 5 to 12 consecutive sidelink symbols, depending on the length of the slot. The number of PSSCH symbols also depends on whether PSFCH is sent in the slot.

The sidelink symbols which carry PSCCH may also include PSSCH via frequency multiplexing when the PSCCH does not span the entire L_{PSSCH} sub-channels. This results in 2 or 3 PSCCH/PSSCH symbols. In sidelink symbols without PSCCH, the PSSCH spans all the L_{PSSCH} sub-channels.

The second sidelink symbol (containing the first PSCCH or PSCCH/PSSCH symbol) is duplicated in the first sidelink symbol for use in automatic gain control (AGC). The symbol after the last PSSCH symbol is used as a guard symbol.

In NR sidelink communications, the PSFCH carries HARQ feedback from RX UE(s) to a TX UE. Within a resource pool, resources for PSFCH can be configured periodically with a period of 1, 2 or 4 slot(s). PSFCH is sent in one symbol among the last sidelink symbols in a PSCCH/PSSCH slot. Prior to the PSFCH symbol, a copy of the PSFCH symbol is transmitted for AGC use, and after the PSFCH symbol, a guard symbol is transmitted. These three sidelink symbols associated with a PSFCH come after all the PSSCH symbols. As a result, the number of PSSCH symbols can be between 2 and 9 symbols (depending on the slot length) when a slot carries PSFCH.

A bandwidth part (BWP) is a contiguous portion of bandwidth within the carrier bandwidth having a single numerology. Using a small BWP reduces the computational complexity and power consumption required of a UE. BWPs can each have a different bandwidth and numerology, which enables more flexible and efficient use of the resources.

The concept of BWP has also been adopted for some NR sidelink communications where a sidelink BWP occupies a contiguous portion of bandwidth within a carrier. In a carrier, a single sidelink BWP may be configured for all UEs. Sidelink UE transmissions and receptions, including physical channels, reference signals and synchronization signals, are contained within the sidelink BWP and employ the same numerology.

The sidelink BWP is divided into common resource blocks (RBs). A common RB consists of 12 consecutive subcarriers with the same subcarrier spacing, where the subcarrier spacing is given by the numerology of the sidelink BWP.

A resource pool consists of contiguous Physical RBs (PRBs) and contiguous or non-contiguous slots that have been configured for sidelink communications. A resource pool must be defined within the sidelink BWP.

Therefore, a single numerology is used within a resource pool. If a UE has an active UL BWP, the sidelink BWP must use the same numerology as the UL BWP if they are both included in the same carrier. Otherwise, the sidelink BWP is deactivated.

In some NR sidelink communications, data in an NR sidelink communication may be organized into TBs carried in a PSSCH. Each TB is associated with a SCI that indicates the resources used by the PSSCH that carries the associated TB, as well as further information required for decoding the TB. The SCI may be transmitted in two parts: a 1^{st}-stage SCI carried in a PSCCH sent with the PSSCH, and a 2^{nd}-stage sent in the PSSCH.

In resource allocation for some NR sidelink communications, sub-channels for the sidelink communications are selected using one of two modes. In a first allocation mode, mode 1, a base station assigns and manages the radio resources for sidelink communications. The first mode may therefore only be used when a UE for which the sub-channel selection is being made is in network coverage.

Mode 1 uses dynamic grant (DG) scheduling and with DG, UEs using mode 1 must request resources from the base station for the transmission of every single TB. The base station sends an indication to the UE of the sidelink resources (i.e., the slot(s) and sub-channel(s)) allocated for the transmission of a TB and up to 2 possible retransmissions of this TB. The UE informs other UEs about the resources it will use to transmit a TB and up to 2 possible retransmissions using the 1^{st}-stage SCI. Mode 1 includes the configured grant scheduling option to reduce the delay by pre-allocating sidelink radio resources. With this scheme, the base station can assign a set of sidelink resources (referred to as a configured grant (CG)) to a UE for transmitting several TBs.

In a second allocation mode (mode 2), UEs autonomously select their sidelink resources (one or several sub-channels) from a resource pool. Accordingly, in mode 2, UEs can operate without network coverage. The resource pool can be configured by the base station when the UE is in network coverage. A UE can select new sidelink resources when it generates a new TB. A new selection can also be triggered to select new sidelink resources.

The UE first defines the selection window where it looks for candidate resources to transmit a TB. The selection window includes all resources within a range of slots determined at the low end by the processing time (in slots) required by a UE to identify candidate resources select new sidelink resources for transmission and at the high end by an implementation-dependent value that must be smaller than the Packet Delay Budget (in slots). The Packet Delay Budget is a latency deadline by which the TB must be transmitted.

When a UE is not transmitting, it senses the sidelink resources during a sensing window in order to identify available candidate resources. The sensing window is a time interval determined according to a resource selection trigger or slot at which new resources must be selected, and a number of slots equivalent to 1100 milliseconds or 100 milliseconds. The time required to complete the sensing procedure is equal to one slot for a sub-channel spacing of 15 or 30 kHz, 2 slots for a sub-channel spacing of 60 kHz, and 4 slots for a sub-channel spacing of 120 kHz.

During the sensing process, the UE decodes any 1^{st}-stage SCI received from other UEs in the sensed sidelink resources. The 1^{st}-stage SCIs indicate the sidelink resources that other UEs have reserved for their TB and SCI transmissions in the PSSCH and PSCCH.

A UE performing a sidelink communication in an unlicensed band acquires the necessary radio resources for a COT. In embodiments, the UE may share its acquired COT with another device. The benefit of such COT sharing is that a device initiating a COT can grant another device the right to use the initiated COT without requiring the target device to initiate its own COT. Initiating a COT usually involves a certain sensing time before transmissions are allowed, while starting transmission in a shared COT requires only a fraction of the sensing time required for initiating a COT.

A COT is characterized by one or more of the following properties:
COT Initiator: The node initiating a COT, e.g. following a channel access procedure as specified in 3GPP TS 37.213.
Channel Access Priority Class: One or more classes that imply e.g. required sensing duration when initiating a COT, MCOT, e.g. as defined in 3GPP TS 37.213.
MCOT: The maximum COT duration of a channel occupancy, counted or measured from the first transmission after initiation of the COT.

In the traditional cellular topology with a centralized scheduler, usually a base station initiates a COT and may share this COT with one or more UEs, or a UE initiates a COT and could share this COT with a base station. In these cases, the sharing of a COT is indicated by a specific field in downlink control information or uplink control information. The COT sharing indicator may include a means to indicate the maximum remaining duration of the COT being shared.

The following definitions are used for the purpose of sidelink channel access mechanisms relating to COT sharing:
Tx UE: A UE that transmits a COT sharing indicator via a sidelink connection.
Rx UE: A UE that receives a COT sharing indicator via a sidelink connection.
COT Initiator: A sidelink device that initiated a channel occupancy e.g., Tx UE.
COT Donor: A sidelink device that transmits a COT sharing indicator, e.g. a Tx UE. The COT Donor may be identical to the COT Initiator.
COT Recipient: A sidelink device that receives a COT sharing indicator, e.g. a Rx UE.

The UE-to-UE COT sharing principles should take into consideration that the COT initiator which is the Tx UE may have connection with multiple Rx UEs or destinations. The COT initiator or the Tx UE could share its initiated COT with multiple Rx UEs or destinations. The COT recipient acting as Rx UEs after receiving the COT sharing indicator could transmit data or feedback in the remaining channel duration.

A SCI format for the UE-to-UE COT sharing operation and how to transmit the COT sharing indicator to multiple Rx UEs or destination IDs is outside the scope of this disclosure. The COT sharing indictor may include a remaining duration in terms of number of physical slots, a channel access priority value, and a destination ID of the COT recipient.

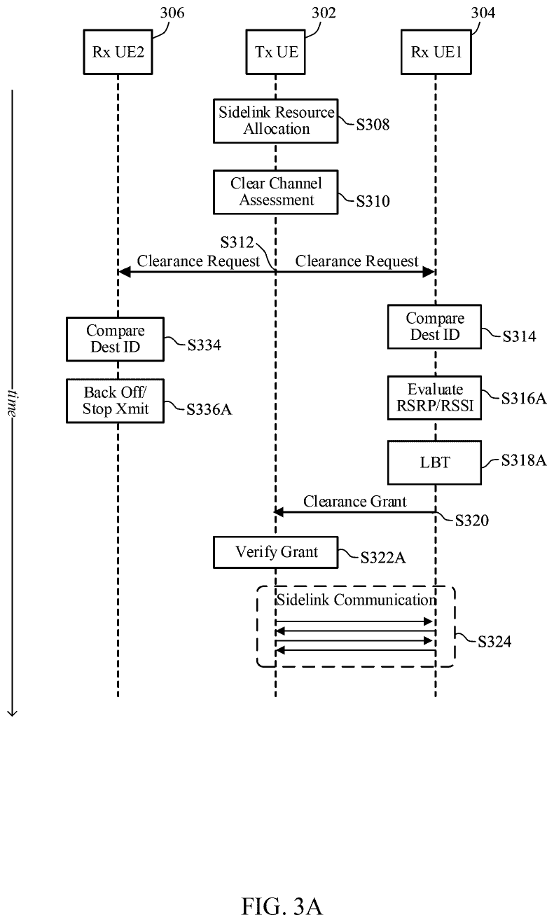

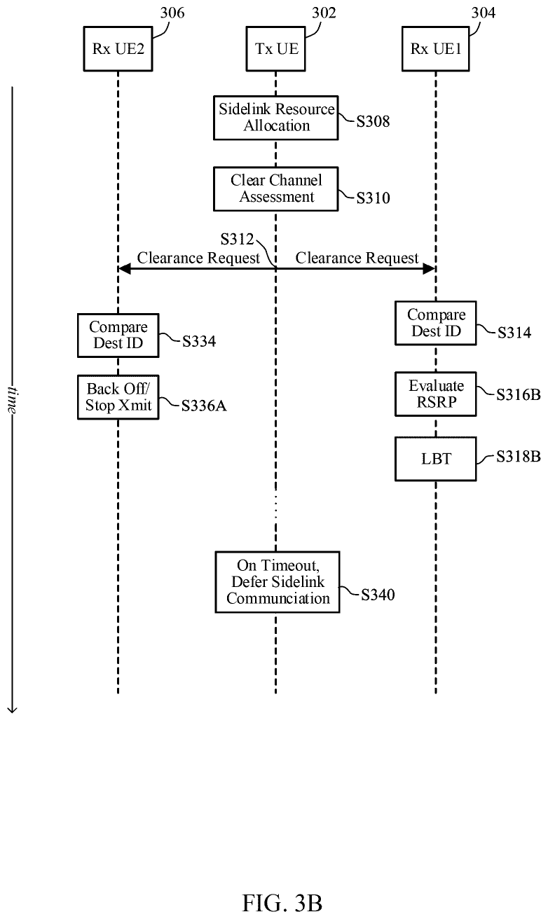

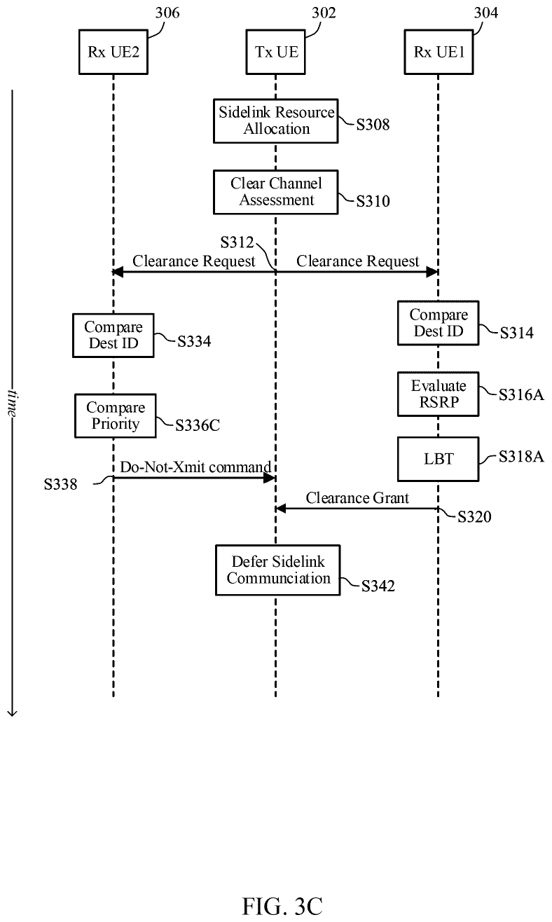

FIGS. 3A through 3C illustrate performing sidelink communications in accordance with embodiments of the present disclosure. In each of FIGS. 3A through 3C, a Tx UE 302 seeks to perform sidelink communications with a first Rx UE 304, and a second Rx UE 306 receives some or all of the sidelink-related communications between the Tx UE 302 and the first Rx UE 304.

FIG. 3A illustrates performing sidelink communications after a successful request/grant handshake between the Tx UE 302 and the first Rx UE 304 in accordance with embodiments of the present disclosure.

At S308, the Tx UE 302 is allocated the radio resources (that is, the slot(s) and sub-channels) for performing the sidelink communications. For example, the radio resources may be allocated to the Tx UE 302 for sidelink communications according to the first or second allocation modes described above, but embodiments are not limited thereto.

At S310, the Tx UE 302 successfully performs a clear channel assessment to determine that the allocated radio resources are not being use by another device. The clear channel assessment may, for example, be based on a Listen Before Talk procedure described in a 3GPP standard, but embodiments are not limited thereto.

Notably, the clear channel assessment only assess the condition of the radio resources at the Tx UE 302, and in some circumstances may detect interference or rival use of the radio resources at the first Rx UE 304.

Accordingly, at S312 the Tx UE 302 may initiate a request/grant protocol by transmitting a clearance request broadcast signal. The Tx UE may have performed the clear channel assessment procedure using a quasi-omnidirectional sensing beam and may transmit the clearance request broadcast signal using a quasi-omnidirectional transmission beam.

The clearance request broadcast signal may include a request information bit set in the first SCI or in the second SCI field, and then the additional information such as the CAPC value, MCOT duration, source-destination ID, or a combination thereof. The clearance request broadcast signal indicates that the first Rx UE 304 is one of one or more target receivers for the sidelink communication. The clearance request broadcast signal does not indicate that the second Rx UE 306 is one of the target receivers for the sidelink communication.

In another implementation, MAC CE may also be used as signaling for transmitting the clearance request broadcast signal with the above information and this MAC CE maybe transmitted together with a SCI.

In embodiments, the request/grant protocol may be initiated based on whether a resource pool to be used for the sidelink communication indicates that the protocol is to be used, a priority of the traffic type being communicated by the sidelink communication, an indication of congestion in the wireless network, a packet delay budget, or a combination thereof. Accordingly, in embodiments, performing the sidelink communication may require successful completion of the request/grant protocol may be performed when the conditions for initiation are present, and may be performed without performing the request/grant protocol otherwise.

The clearance request broadcast signal may be received by one or more Rx UEs that are prospective participants in the sidelink communication (represented in FIG. 3 by the first Rx UE 304) and by one or more one or more Rx UEs that are not prospective participants in the sidelink communication (represented by the second Rx UE 306).

At S314, the first Rx UE 304 determines, using a destination indication in the clearance request broadcast signal (such as an second protocol stack level (L2) source-destination ID) that the Tx UE 302 is requesting it to provide a clearance grant signal. Accordingly, the first Rx UE 304 proceeds to S316A.

At S316A, the first Rx UE 304 may evaluate the strength of the received clearance request broadcast signal to determine whether transmissions from the Tx UE 502 will be received with enough strength to support the sidelink communication. For example, the first Rx UE 304 may determine and evaluate a Reference Signal Received Power (RSRP) or a Received Signal Strength Indicator (RSSI) of the received clearance request broadcast signal. The first Rx UE 304 may also determine a level of interference present in the channel in which the clearance request broadcast signal was received.

At S318A, the first Rx UE 304 may perform a Listen Before Talk (LBT) operation. In embodiments, the LBT operation may be a 3GPP Cat 3 LBT operation. If the LBT operation indicates that the channel is idle, then at S320 the first Rx UE 304 may transmit a clearance grant signal to the Tx UE 302.

The first Rx UE 304 may perform the LBT operation using a directional sensing beam, which may be the beam used to receive the clearance request broadcast signal.

In embodiments, the first Rx UE 304 does not transmit the clearance grant signal when the RSRP or RSSI is worse than a minimum received signal strength threshold.

In other embodiments, the first Rx UE 304 does not transmit the clearance grant signal when a level of interference in the channel in which the clearance request broadcast signal was received is greater than a maximum interference threshold.

In still other embodiments, the first Rx UE 304 does not transmit the clearance grant signal when either of the above conditions is present.

In still other embodiment, the first Rx UE 304 transmits the clearance grant signal regardless of the presence of the above conditions but includes an indication that the Tx UE 502 is not being granted clearance to transmit. The indication may include a reason for not granting the clearance, such as an indication related to an RSRP, an indication related to a level of interference measured by the first Rx UE 304, or both.

In embodiments, the first Rx UE 304 may include in the clearance grant signal an indication of preferred resources (for example, preferred sub-channels) for the sidelink communication. For example, the first Rx UE 304 may indicate a set of sub-channels having a lowest channel loss (as determined using the RSRP or RSSI measured above) or a lowest amount of measured interference as being preferred resources for the sidelink communication.

The clearance grant signal may also include the source-destination ID which correspond to the received clearance request broadcast signal to further associate the clearance grant signal with the clearance request broadcast signal.

The clearance grant signal may also include a Maximum COT (MCOT). The MCOT may be based on an MCOT included in the clearance request broadcast signal. The MCOT included in the clearance grant signal may indicate a maximum channel occupancy duration given by channel access priority class or clearance grant may indicate remaining COT for the sidelink communication, and accordingly may correspond to the MCOT included in the clearance request broadcast signal minus an amount corresponding to a delay between the clearance request broadcast signal being received by the first Rx UE which may correspond to the remaining COT 304 and the clearance grant signal being transmitted by the first Rx UE 304.

In embodiments, the first Rx UE 304 may transmit the clearance grant signal in a PSFCH, a first SCI, a second SCI, higher layer signaling (such as a Media Access Control (MAC) Control Element (CE)), or a combination thereof.

In embodiments, the first Rx UE 304 may transmit the clearance grant signal using a directional transmission beam which was previously established between the source-destination IDs of the Tx UE 302 and the first Rx UE 304.

At S322A, the Tx UE 302 evaluates the clearance grant signal received at S320 to determine if it indicates that the Tx UE 302 has been granted clearance to begin the sidelink communication.

In an embodiment, the Tx UE 302 may determine that clearance is granted in response to receiving a clearance grant signal having the same source-destination ID as the clearance request broadcast signal.

In an embodiment, the Tx UE 302 may determine that clearance is granted in response to receiving a clearance grant signal having the same source-destination ID as the clearance request broadcast signal and having an indication that clearance to transmit is granted set to a value corresponding to true or an indication that clearance to transmit is not granted set to a value corresponding to false.

In an embodiment, the Tx UE 302 may determine that clearance is granted in response to receiving a clearance grant signal having the same source-destination ID as the clearance request broadcast signal and having information on channel conditions at the first Rx UE 304 when the information on channel conditions meets one or more criteria. The one or more criteria may include, for example, that a RSRP or RSSI corresponding to the clearance request broadcast signal is sufficiently high, that interference at the first Rx UE 304 is sufficiently low, or both.

In response to determining that clearance is granted at S322A, at S324 the Tx UE 302 may perform the substantive portion of the sidelink communication; that is, the portion of the sidelink communication remining to be performed after the clearances request/grant protocol, such as data transmission.

Returning to the point in time after the transmission of the clearance request broadcast signal at S312, at S334 the second Rx UE 306 determines, using the destination indication in the clearance request broadcast signal that the Tx UE 302 is not requesting it to provide a clearance grant signal. Accordingly, the second Rx UE 306 proceeds to S336A.

The second Rx UE 306 may at S334 use the same process as used by the first Rx UE 304 at S314, but may arrive at a different result because the pertinent identifier (for example, an L2 source-destination ID) corresponding to the second Rx UE 306 differs from the pertinent identifier corresponding to the first Rx UE 304.

In an embodiment, at S336A, if the second Rx UE 306 seeks to use the radio resources allocated to the sidelink communication, the second Rx UE 306 may implement a random back off for subsequent LBT, where a counter may be set to a random integer value chosen from between 0 and a preconfigured contention window size. Subsequently, the second Rx UE 306 may defer performing sensing for idle slots until the counter decrements to zero.

In an embodiment, at S336A, the second Rx UE 306 may compare a priority of the traffic type indicated in the clearance request broadcast signal to a priority of traffic that the second Rx UE 306 is communicating or intends to communicate. If the priority of the traffic type indicated in the clearance request broadcast signal is higher, then the second UE may defer transmission of its traffic until an MCOT indicated in the clearance request broadcast signal has elapsed.

In an embodiment, at S336A, the second Rx UE 306 may compare an RSRP of the clearance request broadcast signal to a preconfigured threshold value. If the RSRP is above the threshold, then in order to not interfere with the sidelink communication, the second Rx UE 306 may defer transmission of its traffic until the MCOT indicated in the clearance request broadcast signal has elapsed.

FIG. 3B illustrates an attempt to perform sidelink communications wherein a request/grant handshake between the Tx UE 302 and the first Rx UE 304 in accordance with embodiments of the present disclosure is unsuccessful.

In FIG. 3B, steps S308, S310, S312, S314, S334, and S336A are as described with respect to FIG. 3A, and repetition of that description is omitted in the interest of brevity.

The process of FIG. 3B differs from the process of FIG. 3A in that in S316B, S318B, or both, one of the criteria for granting clearance to perform the sidelink communication described with respect to S316A and S318A is not met. Accordingly, the first Rx UE 304 either does not transmit the clearance grant signal, or (not shown) transmits a signal indicating that clearance is not granted.

At S340, when the first Rx UE 304 does not transmit the clearance grant signal, the Tx UE 302 waits for the expiration of a timeout duration, and upon expiration of the timeout duration without reception of a clearance grant signal defers the sidelink communication.

In an embodiment, the Tx UE 302 may also defer the sidelink communication in response to receiving a signal indicating that clearance is not granted.

In embodiments, the Tx UE 302 may in some cases cancel the sidelink communication instead of deferring it. Such cases may include when the sidelink communication is best-effort, when a retry count is exceeded, and so on.

FIG. 3C illustrates an attempt to perform sidelink communications wherein a request/grant handshake between the Tx UE 302 and the first Rx UE 304 in accordance with embodiments of the present disclosure is superseded by a response to the request/grant handshake generated by the second Rx UE 306.

In FIG. 3C, steps S308, S310, S312, S314, S316A, S318A, S320, and S334 are as described with respect to FIG. 3A, and repetition of that description is omitted in the interest of brevity.

The process of FIG. 3C differs from the process of FIG. 3A in that in S336C, the priority of the traffic type indicated in the clearance request broadcast signal is less than a priority of traffic that the second Rx UE 306 is communicating or intends to communicate. In response, at S338 the second Rx UE 306 transmits a ‘do not transmit’ command to the Tx UE 302.

At S342, in response to receiving the ‘do not transmit’ command the Tx UE 302 may defer (or in some cases cancel) the sidelink communication.

The Tx UE 302 may perform clear channel assessment using a quasi-omnidirectional beam but may transmit the clearance request broadcast signal using a plurality of transmission beams associated with the sensing beam. The clearance grant signal may be transmitted from the first Rx UE 304 considering each of the directional beam using a beam correspondence. There may be a one-to-one mapping between radio resources (such as slot(s), sub-channel(s), or both) used by the clearance request broadcast signal and radio resources used by a corresponding clearance grant signal.

In embodiments, the first Rx UE 304 does not transmit a clearance request broadcast signal in a transmission having a measured RSSI/RSRP above a preconfigured threshold. This may be useful in selecting a suitable transmission beam for the Tx UE 302 to use.

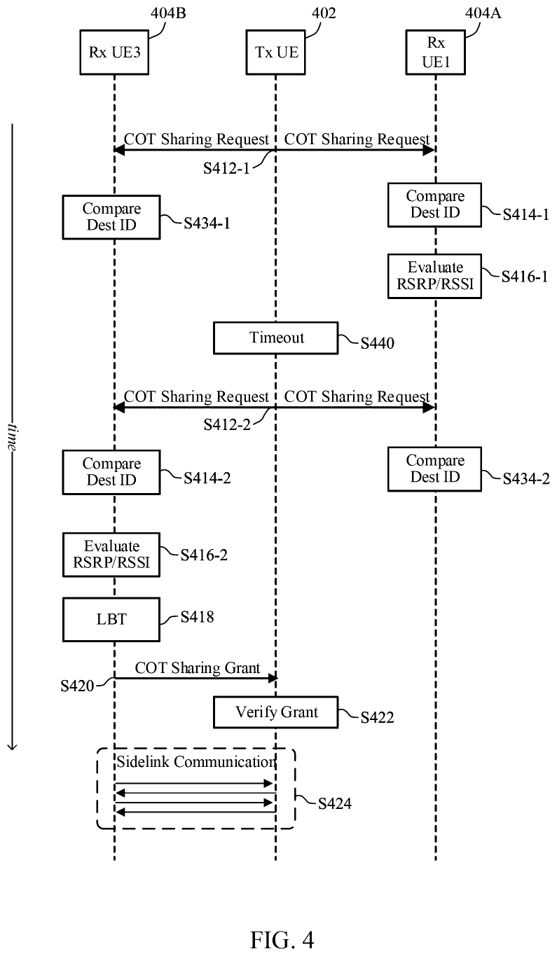

FIG. 4 illustrates performing COT sharing in a sidelink communications after a successful request/grant handshake between a Tx UE 402 and a third Rx UE 404B in accordance with embodiments of the present disclosure.

FIG. 4 shows the Tx UE 402, a first Rx UE 404A, and a third Rx UE 404B. In embodiments, the Tx UE 402 corresponds to the Tx UE 302 of FIGS. 3A through 3C, and the first and a third Rx UEs 404A and 404B each correspond to the first Rx UE 304 of FIGS. 3A through 3C that participates in sidelink communications with a Tx UE.

The Tx UE 402, a first Rx UE 404A, and a third Rx UE 404B are assumed to all be involved in a sidelink communication that has remaining COT at the start of the process shown in FIG. 4, and the Tx UE 402, having finished transmitting its own data, may have determined to share the COT with one or more of the first and a third Rx UEs 404A and 404B.

At S412-1, the Tx UE 402 transmits a first COT sharing request indicating that the Tx UE 402 intends to share the COT and identifying the first Rx UE 404A as a candidate for sharing the COT. The first COT sharing request may include the information included in the clearance request broadcast signal described with respect to FIG. 3A. The first COT sharing request may correspond to a clearance request broadcast signal having an indication that the clearance being requested is for COT sharing.

At S414-1, the first Rx UE 404A determines that the first COT sharing request is intended for it, using a process similar to that described for S314 of FIG. 3A. The first Rx UE 404A then determines, at S416-1, whether to grant the first COT sharing request, using a process similar to that described with respect to S316B and/or S318B of FIG. 3B.

Similarly to in FIG. 3B, the first Rx UE 404A determines to not grant the COT sharing request, and accordingly does not transmit a COT sharing grant to the Tx UE 402.

In another embodiment (not shown), the first Rx UE 404A may transmit a signal to the Tx UE 402 indicating that the COT sharing request has been declined.

At S440, after a timeout occurs (or after receiving from the first Rx UE 404A the signal indicating that the COT sharing request has been declined), at S412-2, the Tx UE 402 transmits a second COT sharing request indicating that the Tx UE 402 intends to share the COT and identifying the third Rx UE 404B as a candidate for sharing the COT. The second COT sharing request may include the information included in the clearance request broadcast signal described with respect to FIG. 3A.

At S414-2, the third Rx UE 404B determines that the second COT sharing request is intended for it, using a process similar to that described for S314 of FIG. 3A. The third Rx UE 404B then determines, at S416-2, whether to grant the COT sharing request, using a process similar to that described with respect to S316A and/or S318A of FIG. 3A.

Similarly to in FIG. 3A, the third Rx UE 404B determines to grant the second COT sharing request, and accordingly at S420 transmits a COT sharing grant signal to the Tx UE 402. The COT sharing grant signal may include the information included in the clearance grant signal described with respect to FIG. 3A, and may be transmitted in one or more of the manners described for the clearance grant signal.

At S422, the Tx UE 402 verifies that the COT sharing has been granted using the received COT sharing grant signal. Subsequently, at S424 additional transactions of the sidelink communication are preformed to communicate the data of the third Rx UE 404B.

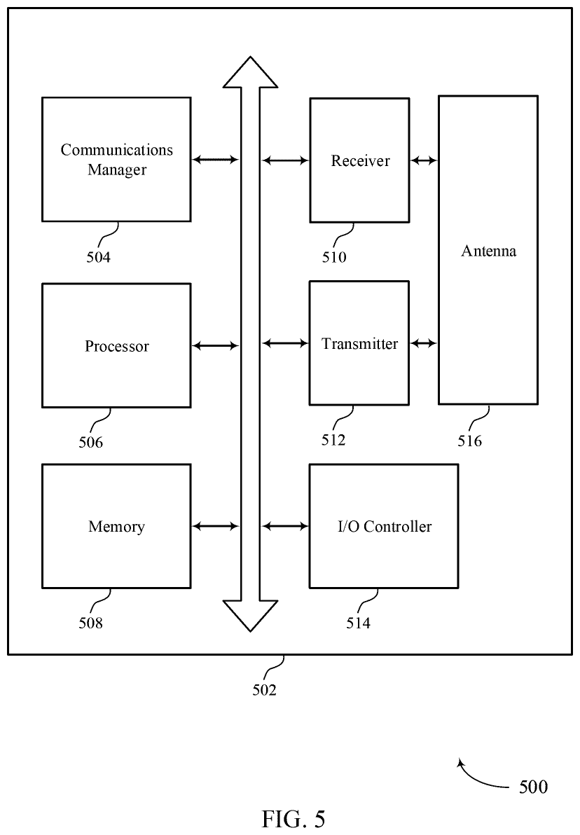

FIG. 5 illustrates a block diagram 500 of a device 502 that supports a clearance request/grant handshake for performing sidelink communication in an unlicensed band in a wireless communications network in accordance with aspects of the present disclosure. The device 502 may be an example of a UE 104 as described herein. The device 502 may support wireless communication with one or more base stations 102, UEs 104, other devices that implement respective network functions, or any combination thereof. The device 502 may include components for bi-directional communications including components for transmitting and receiving communications, such as a communications manager 504, a processor 506, a memory 508, a receiver 510, transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication at a first device (e.g., the device 502) in accordance with examples as disclosed herein. The communications manager 504 may be configured as or otherwise support a means of performing a request/grant protocol to prevent frame collisions and other issues such as may be caused by hidden or exposed nodes when performing sidelink communications in an unlicensed band.

The processor 506 may include an intelligent hardware device (e.g., a general-purpose processor, a Digital Signal Processor (DSP), a Central Processor Unit (CPU), a microcontroller, an Application-Specific Integrated Circuit (ASIC), a Field-Programmable Gate Array (FPGA), a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

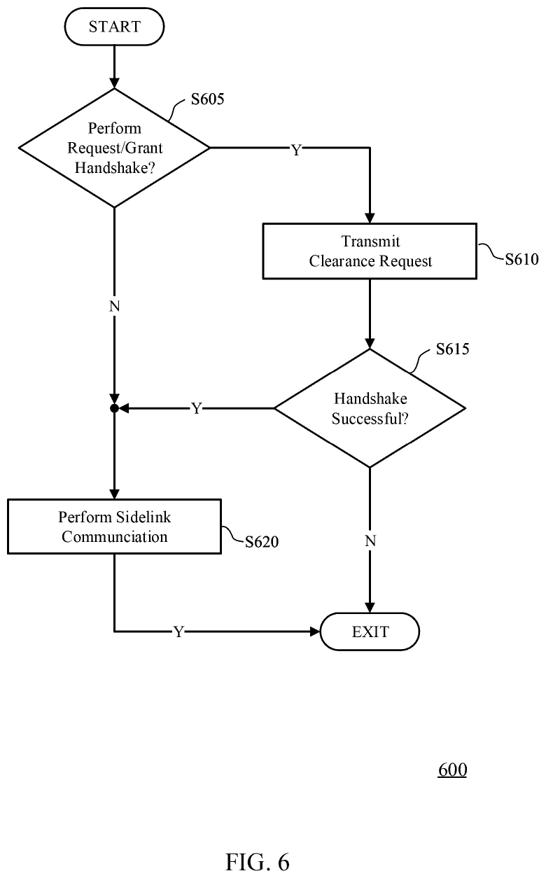

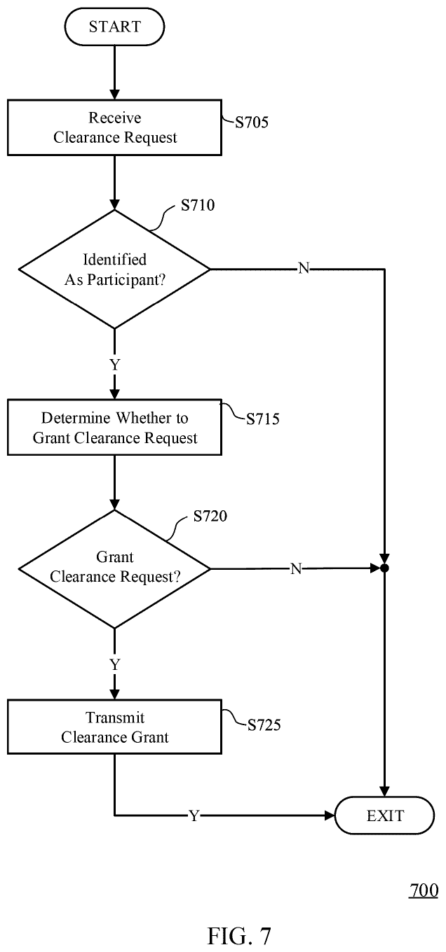

FIGS. 6 and 7 illustrate flowcharts of methods that support sidelink communications in accordance with aspects of the present disclosure.

FIG. 6 illustrates a flowchart of a method 600 that supports sidelink communications in accordance with aspects of the present disclosure. The method 600 may be performed by a device operating as a Tx UE.

At S605, the device determines whether to perform a clearance request/grant handshake before performing a sidelink communication with one or more Rx UEs in an unlicensed band. The determination may be based on a level of wireless network congestion, a priority of traffic to be communicated in the sidelink communication, or a combination thereof.

In response to determine to perform the clearance request/grant handshake, at S605 the device proceeds to S610; otherwise the device proceeds to S620.

At S610, the device transmits a clearance request broadcast signal indicating the one or more Rx UEs. The clearance request broadcast signal may be transmitted using radio resources allocated to the sidelink communication.

At S615, the device determines whether the clearance request/grant handshake has completed successfully. The clearance request/grant handshake completes successfully when a clearance grant signal is received from the one or more Rx UEs.

In embodiments, the clearance request/grant handshake completes unsuccessfully when a clearance grant signal is not received before the end of a timeout period following transmission of the clearance request broadcast signal.

In embodiments, the clearance request/grant handshake completes unsuccessfully when a do-not-transmit signal transmitted in response to the clearance request broadcast signal is received.

In response to determine that the clearance request/grant handshake has completed successfully, at S615 the device proceeds to S620; otherwise the device exits the method 600.

At S620 the device initiates the sidelink communication with the one or more Rx UEs.

In embodiments, the sidelink communication may be a COT sharing communication that utilizes a remaining MCOT of another (already initiated) sidelink communication.

The operations S605 through S620 performed by the device may be performed in accordance with examples as described herein. In some implementations, aspects of the operations may be performed by a device as described with reference to FIG. 5.

FIG. 7 illustrates a flowchart of a method 700 that supports sidelink communications in accordance with aspects of the present disclosure. The method 700 may be performed by a device operating as an Rx UE.

At S705, the device receives a clearance request broadcast signal from a Tx UE. The clearance request broadcast signal comprises a clearance request to perform a sidelink communication on an unlicensed band.

In embodiments, the sidelink communication may be a COT sharing communication that utilizes a remaining MCOT of another (already initiated) sidelink communication.

At S705, the device determines whether the clearance request broadcast signal identifies the device as a participant in the sidelink communication. In embodiments, the determination is performed by comparing an identifier included in the clearance request broadcast signal to an identifier associated with the device.

When the device determines that the clearance request broadcast signal identifies the device as a participant in the sidelink communication, at S710 the device proceeds to S715; otherwise, the device exits the method 600.

At S715, the device determines whether to grant the clearance request.

In embodiments, the device determines to grant the clearance request based on a received strength of the clearance request broadcast signal at the device, a level of interference on radio resource pertinent to the sidelink communication at the device, or a combination thereof.

At S720, if the device determines to grant the clearance request, the device proceeds to S725.

At S720, if the device determines not to grant the clearance request, the device exits the method 700.

In embodiments, if the device determines not to grant the clearance request, the device transmits a signal indicating that the clearance request is denied, such as a do-not-transmit signal, to the Tx UE before exiting the method 700.

At S725, the device transmits a clearance grant signal to the Tx UE. The clearance grant signal may include a source-destination identifier corresponding to a source-destination identifier included in the clearance request broadcast signal, information on a signal strength of the clearance request broadcast signal at the device, information on an amount of interference present at the device on radio resources pertinent to the sidelink communication, or a combination thereof.

The operations S705 through S725 performed by the device may be performed in accordance with examples as described herein. In some implementations, aspects of the operations may be performed by a device as described with reference to FIG. 5.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1.-10. (canceled)

11. A user equipment (UE) for wireless communication, comprising:
at least one memory; and
at least one processor coupled with the at least one memory and configured to cause the UE to:
receive, from a transmitting (Tx) UE, a clearance request broadcast signal regarding a sidelink communication in an unlicensed band;
determine whether the clearance request broadcast signal identifies the UE as participating in the sidelink communication; and
in response to determining that the clearance request broadcast signal identifies the UE as participating in the sidelink communication, determine whether to grant the Tx UE clearance to perform the sidelink communication.

12. The UE of claim 11, wherein the at least one processor is further configured to cause the UE to, in response to determining to grant the Tx UE clearance to perform the sidelink communication, transmit a clearance grant signal to the Tx UE.

13. The UE of claim 12, wherein the clearance grant signal includes an identifier corresponding to an identifier included in the clearance request broadcast signal, information regarding a received signal strength of the clearance request broadcast signal, information regarding interference present at the UE, or a combination thereof.

14. The UE of claim 12, wherein transmitting the clearance grant signal to the Tx UE includes performing a Listen Before Talk operation before transmitting the clearance grant signal to the Tx UE.

15. The UE of claim 11, wherein determining whether the clearance request broadcast signal identifies the UE as participating in the sidelink communication includes comparing an identifier included in the clearance request broadcast signal to an identifier associated with the UE.

16. The UE of claim 11, wherein the at least one processor is further configured to cause the UE to, in response to determining not to grant the Tx UE clearance to perform the sidelink communication, transmit a signal to the Tx UE indicating that the sidelink communication is not to be performed.

17. The UE of claim 11, wherein the sidelink communication is a Channel Occupancy Time (COT) sharing communication.

18. The UE of claim 11, wherein the at least one processor is further configured to cause the UE to, in response to determining that the clearance request broadcast signal does not identify the UE as participating in the sidelink communication, terminate a communication being performed by the UE, perform a back-off operation, or both.

19. (canceled)

20. (canceled)

21. A user equipment (UE) for wireless communication, comprising:
at least one memory; and
at least one processor coupled with the at least one memory and configured to cause the UE to:
determine whether to perform a channel access handshake for sidelink communication in an unlicensed band; and
in response to a determination to perform the channel access handshake:
perform a first channel access handshake, wherein the first channel access handshake comprises a broadcast of a first channel access request signal that identifies one or more first UEs, using allocated resources for the sidelink communication; and
perform the sidelink communication with the one or more first UEs in response to a successful completion of the first channel access handshake, wherein the successful completion of the first channel access handshake is based on reception of a first channel access response signal from the one or more first UEs.

22. The UE of claim 21, wherein the first channel access request signal comprises one or more source-destination identifiers, and wherein each source-destination identifier identifies a corresponding UE of the one or more first UEs.

23. The UE of claim 21, wherein the at least one processor is further configured to cause the UE to determine to perform the channel access handshake based on one or more of a level of network congestion or a priority of the sidelink communication.

24. The UE of claim 21, wherein the first channel access handshake completes unsuccessfully based on no reception of the first channel access response signal in response to the broadcasted first channel access request signal and before an expiration of a timeout interval.

25. The UE of claim 21, wherein the first channel access handshake completes unsuccessfully based on a reception of a second channel access response signal from a UE other than the one or more first UEs, and wherein the second channel access response signal indicates to not perform the sidelink communication.

26. The UE of claim 21, wherein the at least one processor is further configured to cause the UE to:
in response to a determination to not perform the channel access handshake:
not perform the channel access handshake; and
perform the sidelink communication.

27. The UE of claim 21, wherein the channel access handshake comprises a clearance request/grant handshake, and wherein the sidelink communication is associated with a Channel Occupancy Time (COT).

28. The UE of claim 27, wherein the at least one processor is further configured to cause the UE to:
in response to the first channel access handshake completing unsuccessfully, perform a second channel access handshake, wherein the second channel access handshake comprises a broadcast of a second channel access request signal that identifies one or more second UEs other than the one or more first UEs.

29. The UE of claim 21, wherein the first channel access response signal comprises one or more of:
a source-destination identifier,
information on a signal strength of the broadcasted first channel access request signal, or
information on an amount of interference.

30. The UE of claim 21, wherein the first channel access request signal is broadcasted on a plurality of transmission beams, wherein the first channel access response signal is received using the plurality of transmission beams, and
wherein the at least one processor is further configured to cause the UE to:
select a transmission beam from the plurality of transmission beams for the sidelink communication based on one or more channel characteristics.

31. A processor for wireless communication, comprising:
at least one controller coupled with at least one memory and configured to cause the processor to:
determine whether to perform a channel access handshake for sidelink communication in an unlicensed band; and
in response to a determination to perform the channel access handshake:
perform a first channel access handshake, wherein the first channel access handshake comprises a broadcast of a first channel access request signal that identifies one or more first UEs, using allocated resources for the sidelink communication; and
perform the sidelink communication with the one or more first UEs in response to a successful completion of the first channel access handshake, wherein the successful completion of the first channel access handshake is based on reception of a first channel access response signal from the one or more first UEs.

32. A method performed by a user equipment (UE), the method comprising:
determining whether to perform a channel access handshake for sidelink communication in an unlicensed band; and
in response to a determination to perform the channel access handshake:
performing a first channel access handshake, wherein the first channel access handshake comprises a broadcast of a first channel access request signal that identifies one or more first UEs, using allocated resources for the sidelink communication; and
performing the sidelink communication with the one or more first UEs in response to a successful completion of the first channel access handshake, wherein the successful completion of the first channel access handshake is based on reception of a first channel access response signal from the one or more first UEs.
